(19) United States
(12) Patent Application Publication
(10) Pub. No.: US 2007/0280673 A1
(43) Pub. Date: Dec. 6, 2007

(54) Lens-interchangeable digital camera

(76) Inventors: Kazuo Mikami, Iruma-shi (JP); Yoichiro Okumura, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/807,041

(22) Filed: May 24, 2007

(30) Foreign Application Priority Data
May 31, 2006 (JP) 2006-150965
May 31, 2006 (JP) 2006-150966

(51) Int. Cl. G03B 19/12

(52) U.S. Cl. 396/354; 396/374; 396/529

(57) ABSTRACT

In a lens-interchangeable digital camera having a half mirror arranged in a shooting optical path and capable of displaying a live view, the half mirror is made movable between a position inserted into the shooting optical path and a position retracted from the shooting optical path, and when power-on is detected, the movable half mirror is returned to the position in the shooting optical path, while when power-off is detected, the movable half mirror is retracted from the shooting optical path. Further, upon detecting the mounting state of a lens barrel, when removal of the lens barrel is detected, the movable half mirror is retracted, while when mounting of the lens barrel is detected, the movable half mirror is returned.

### CROSS-REFERENCE TO RELATED APPLICATION

This application is based upon and claims the benefit of priority from prior Japanese Patent Application No. 2006-150965 and 2006-150966 filed on May 31, 2006, the entire contents of which are incorporated herein by reference.

### BACKGROUND OF THE INVENTION

1. Field of the Invention

The present invention relates to a lens-interchangeable digital camera having a so-called electronic finder function (also referred to as a live-view display function) for displaying an image acquired by an image pickup device on a display device as a moving image.

2. Description of the Related Art

While the traditional digital camera was designed to view a subject image through an optical finder, a growing number of recent digital cameras have eliminated the optical finder and incorporated an electronic finder function for displaying an image acquired by an image pickup device continuously on a display device such as an LCD monitor for subject image viewing.

As a digital camera having such an electronic finder display function, a lens-interchangeable camera is disclosed, for example, in Japanese Patent Application Laid-Open No. 2002-369042. In the lens-interchangeable camera, a movable mirror is retracted from a shooting optical path and a focal-plane shutter is fully opened to guide a subject image to an image pickup device, thereby displaying a subject image acquired by the image pickup device continuously on the LCD monitor.

Further, Japanese Patent Application Laid-Open No. 2002-6208 proposes a digital camera having a movable mirror formed into a half mirror so that part of a subject light beam that passed through a photographing optical system will be transmitted through the half mirror to reach an image pickup device and the remaining part of the subject light beam will be reflected to reach a phase-difference AF sensor. According to this structure, the phase-difference AF is enabled while providing an electronic finder display.

### BRIEF SUMMARY OF THE INVENTION

According to the invention of the present application, a movable half mirror is made movable between a position inserted into a shooting optical path and a position retracted from the shooting optical path, and when power-on is detected, the movable half mirror is returned to the position in the shooting optical path, while when power-off is detected, the movable half mirror is retracted. Further, upon detecting the mounting state of a lens barrel, when removal of the lens barrel is detected, the movable half mirror is retracted, while when mounting of the lens barrel is detected, the movable half mirror is returned.

One aspect of the present invention is to provide a lens-interchangeable digital camera capable of removably mounting a photographing lens, the digital camera comprising: a mirror member capable of being moved in and out of the optical path of the photographing lens and having properties to reflect part of a subject light beam and transmit the remaining part of the subject light beam in the optical path; a drive mechanism for moving the mirror member into or out of the optical path of the photographing lens; a focus detection sensor for receiving a light beam reflected by the mirror member to detect the focus state of the photographing lens when the mirror member is located in the optical path; an image pickup device for receiving the subject light beam transmitted through the mirror member to output a subject image signal when the mirror member is located in the optical path; an electronic finder for displaying the subject image signal output from the image pickup device; and a control circuit for stopping the display operation of the electronic finder and retracting the mirror member from the optical path of the photographing lens when the photographing lens is removed while the display operation of the electronic finder is being performed.

Another aspect of the present invention is to provide a lens-interchangeable digital camera capable of removably mounting a photographing lens, the digital camera comprising: a mirror member capable of being moved in and out of the optical path of the photographing lens and having properties to reflect part of a subject light beam and transmit the remaining part of the subject light beam in the optical path; a drive mechanism for moving the mirror member into or out of the optical path of the photographing lens; a light-receiving sensor for receiving a light beam transmitted through or reflected by the mirror member to output a subject image signal when the mirror member is located in the optical path; and a control circuit for stopping the signal output operation of the light-receiving sensor and moving the mirror member out of the optical path of the photographing lens when the photographing lens is removed.

Still another aspect of the present invention is to provide a lens-interchangeable digital camera capable of removably mounting a photographing lens, the digital camera comprising: a mirror member capable of being moved in and out of the optical path of the photographing lens and having properties to reflect part of a subject light beam and transmit the remaining part of the subject light beam in the optical path; a drive mechanism for moving the mirror member into or out of the optical path of the photographing lens; a light-receiving sensor for receiving a light beam transmitted through or reflected by the mirror member to output a subject image signal when the mirror member is located in the optical path to output; and a control circuit for moving the mirror member out of the optical path of the photographing lens and stopping the operation of the light-receiving sensor in such a state that the photographing lens has been removed.

Yet another aspect of the present invention is to provide a lens-interchangeable digital camera capable of removably mounting a photographing lens, the digital camera comprising: a mirror member capable of being moved in and out of the optical path of the photographing lens and having a property to reflect part of incident light, the mirror member being a thin-film mirror or a glass mirror with a thickness of 0.2 mm or less; and a control part for moving the mirror member to a predetermined retracted position when the photographing lens is removed, wherein the retracted position is a position where the mirror member is less likely to interfere with an extraneous material entering from an opening of a lens mount part.

Yet another aspect of the present invention is to provide a control method for a lens-interchangeable camera for capturing a subject image through a mirror member to enable displaying of a moving picture based on the captured subject image, the mirror member capable of being moved in and out of the optical path of a photographing lens and having a light-transmissive property, the control method comprising the steps of:

stopping the moving picture display and moving the mirror member out of the optical path of the photographing lens when removal of the photographing lens is detected while the moving picture is being displayed; and moving the mirror member back into the optical path and restarting the moving picture display when remounting of the photographing lens is detected.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 an exterior perspective view of a digital camera according to a preferred embodiment of the present invention as viewed from its backside;

FIG. 2 is a block diagram showing the general structure of an electric system of the digital camera according to the preferred embodiment to which the present invention is applied;

FIG. 3 is a perspective view showing the structure of components of a movable half mirror according to the preferred embodiment of the present invention;

FIG. 4 is a flowchart showing a power-on reset operation according to the preferred embodiment of the present invention;

FIG. 5 is a flowchart of a shooting operation according to the preferred embodiment of the present invention; and

FIG. 6 contains schematic views showing the structure of a mounting/demounting detection switch according to the preferred embodiment of the present invention.

### DETAILED DESCRIPTION OF THE PREFERRED EMBODIMENT

A preferred embodiment of the invention is described below with reference to the accompanying drawings.

The preferred embodiment is described below using a digital camera to which the present invention is applied.

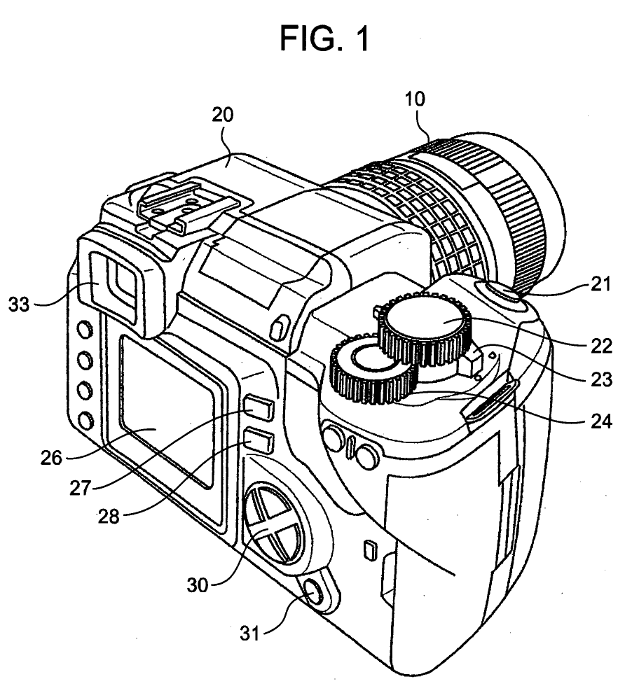

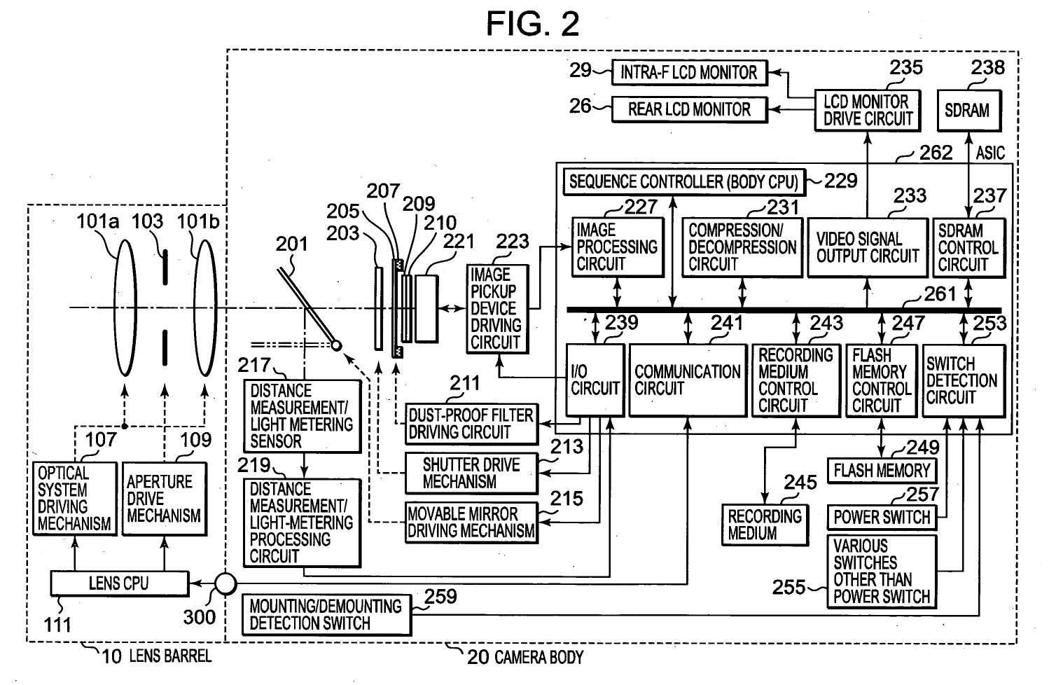

FIG. 1 is an exterior perspective view of the digital camera according to the embodiment of the present invention as viewed from its backside. This camera consists principally of a camera body 20 and a lens barrel 10 as an interchangeable photographing lens. The lens barrel 10 is removably mounted on a mount opening portion (not shown) provided on the front of the camera body 20. A subject light beam from the photographing lens composed of lenses 101a, 101b, etc. (see FIG. 2) is guided into the camera body 20 through the mount opening portion. In the embodiment, the lens barrel 10 and the camera body 20 are constructed separately and electrically connected through a communication contact 300 (see FIG. 2). Further, a mounting/demounting detection switch 259 (see FIG. 2) is provided in the camera body 20 to enable detection of the mounting state of the lens barrel 10 on the camera body 20 (as to whether the lens barrel 10 is mounted on the camera body 20 properly, i.e., whether the lens barrel 10 is detached from the camera body 20).

A release button 21, a mode dial 22, a power switch lever 23, a control dial 24, etc. are arranged on the top face of the camera body 20. The release button 21 has a first release switch to be turned on when a camera user presses the release button 21 halfway and a second release switch to be turned on when the camera user fully presses the release button 21. When this first release switch (hereinafter abbreviated as “1R”) is turned on, the camera performs shooting preparation operations, such as focus detection, focusing of the photographing lens, measuring subject brightness, etc. Then, when the second release switch (hereinafter abbreviated as “2R”) is turned on, the camera performs a shooting operation for capturing image data of a subject image based on the output of a CCD (Charge Coupled Device) 221 (see FIG. 2) as an image pickup device.

The mode dial 22 is a rotatable operating member. The mode dial 22 can be set to any pictorial indication or letter symbol provided on the mode dial 22 to indicate each shooting mode in order to select the set shooting mode. The shooting modes include a full-auto shooting mode (AUTO), a program shooting mode (P), an aperture priority shooting mode (A), a shutter speed priority shooting mode (S), a manual shooting mode (M), a portrait shooting mode, a landscape shooting mode, a macro shooting mode, a sport shooting mode, a night scene shooting mode, etc. The power switch lever 23 is an operating member to power on or off the digital camera (i.e., an operating member to shift the digital camera from a non-operating state to an operating state, or vice versa). The power switch lever 23 is rotatable between two positions, namely on and off positions. The control dial 24 is a rotatable operating member. When the control dial 24 is turned on an information display screen or the like, a desired setting value, mode, or the like can be selected.

On the back face of the camera body 20, a rear LCD monitor 26, a playback button 27, a menu button 28, an arrow pad 30, an OK button 31, and a finder eyepiece part 33 are arranged. The rear LCD monitor 26 is a display device functioning as an electronic finder to provide a display for subject image viewing, for playback-displaying shot subject images, and for displaying camera information or a menu. The display device is not limited to the LCD as long as it can display all of the above. The display device can also be such that its inclination angle can be changed at will with respect to the camera body 20. The finder eyepiece part 33 is an eyepiece window for viewing a subject image, and an intra-finder LCD monitor 29 to be described later is arranged in the finder eyepiece part 33, allowing the camera user to view the subject image through this finder eyepiece part 33. The playback button 27 is an operation button to instruct the camera to display a subject image recorded after shot on the rear LCD monitor 26. In response to actuation of the playback button 27, image data of a subject compressed in JPEG or the like and stored in an SDRAM 238 or recording medium 245 to be described later is decompressed and displayed on the rear LCD monitor 26.

The arrow pad 30 is an operating member to instruct the movement of a cursor two-dimensionally in the X and Y directions on the rear LCD monitor 26. The arrow pad 30 is also used to select an image recorded on the recording medium 245 and to be played back upon displaying a subject image. Instead of providing four buttons, namely UP, DOWN, RIGHT, and LEFT buttons, the arrow pad 30 can be replaced by a two-dimensionally operable switch capable of detecting operating directions on the two dimensions such as a touch switch. The OK button 31 is an operating member to confirm each of various items selected using the arrow pad 30, the control dial 24, or the like. The menu button 28 is a button for switching to a menu mode to set various modes of this digital camera. When the menu mode is selected at the press of this menu button 28, a menu screen appears on the rear LCD monitor 26. The menu screen has a multi-layered structure, so that the camera user can select any of the various items using the arrow pad 30 and confirm the selected item by pressing the OK button 31.

These release button 21, power switch lever 23, playback button 27, menu button 28, arrow pad 30, and OK button 31 are linked with ON/OFF switches, respectively. Then, signals generated in response to actuation of the operation buttons linked with the respective ON/OFF switches and the operating members such as the mode dial 22 and the control dial 24 are sent to a switch detection circuit 253 (see FIG. 2) inside an ASIC (Application Specific Integrated Circuit) 262.

Referring next to FIG. 2, the general structure of the digital camera will be described, mainly about its electric system. Inside the lens barrel 10, lenses 101a and 101b for focus adjustment and focal length adjustment, and an aperture 103 for adjusting the amount of light passing therethrough are arranged. The lenses 101a, 101b and the aperture 103 are so connected that the lenses 101a, 101b will be driven by an optical system driving mechanism 107 and the aperture 103 will be driven by an aperture drive mechanism 109. The optical system driving mechanism 107 and the aperture drive mechanism 109 are connected to a lens CPU 111, respectively, and the lens CPU 111 is connected to the camera body 20 through the communication contact 300. The lens CPU 111 controls the components inside the lens barrel 10. In other words, the lens CPU 111 controls the optical system driving mechanism 107 to perform focusing and zoom driving, while it controls the aperture drive mechanism 109 to control the aperture value.

A movable reflecting mirror (hereinafter referred to as “movable half mirror” for convenience) 201 having the property of transmitting part of a light beam passing through the lenses 101a, 101b is arranged inside a mirror box of the camera body 20.

The mirror portion of this movable half mirror is a pellicle mirror formed by stretching and bonding to a base frame a very thin semi-transparent film with a thickness of about 20 μm, or a glass mirror formed by depositing silver on a thin glass plate with a thickness of 0.2 mm or less. The reason for using such a thin mirror member as the movable half mirror is to prevent discernible ghosting, or generation of double images, in the reflected light.

However, since this type of mirror member is very thin, there is a danger that it could easily be damaged if the camera user touches it with his or her finger or the like, for example, upon changing the lens. Therefore, some contrivance is necessary to make it difficult for the camera user to touch it upon changing the lens.

The movable half mirror 201 is rotatable about a rotation axis 201a provided along a direction perpendicular to the paper surface of FIG. 2, and is driven by a movable mirror driving mechanism 215 from a position inside the shooting optical path of the lens barrel 10 to a position outside of the optical path, or vice versa. When the movable half mirror 201 is at a position 45 degrees inclined with respect to the optical path of the lenses 101a, 101b (as indicated by a solid line in FIG. 2), part of the subject light beam (e.g., 30 percent thereof) is reflected and guided to a distance measurement/light metering sensor 217 (second light-receiving sensor) provided at the bottom of the camera body 20, while the remaining part of the subject light beam (70 percent) is transmitted through the movable half mirror 201 and guided toward the CCD 221. On the other hand, when the movable half mirror 201 is at a retracted position substantially parallel to the optical path of the lenses 101a, 101b and hence not to block the subject light-beam (as indicated by a chain double-dashed line in FIG. 2), the entire subject light beam is guided to the CCD 221.

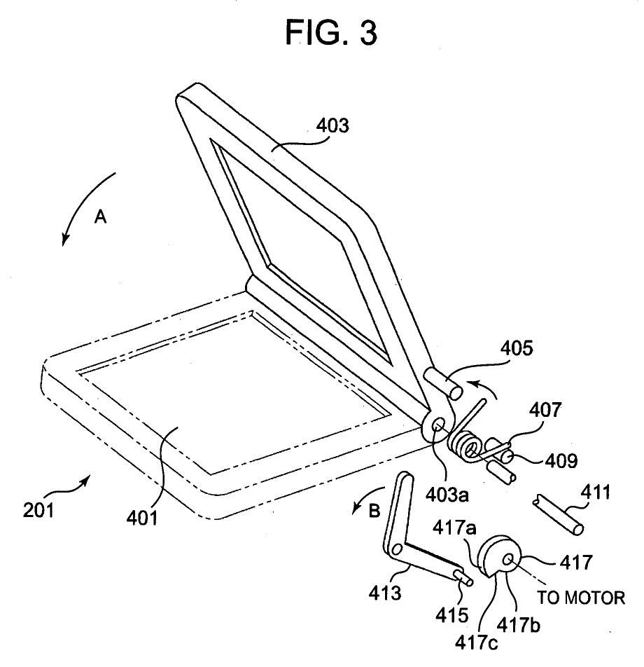

The structure of this movable half mirror 201 will be described later with reference to FIG. 3. In the embodiment, the rotation center of the movable half mirror 201 is located on the lower side of the mirror box, but the present invention is not limited to this location. The rotation center may be located on the upper side, or it may of course be located on either the right or left side of the mirror box in a direction parallel to the paper surface of FIG. 2.

The distance measurement/light metering sensor 217 is arranged at the bottom of the mirror box in the camera body 20 and in a position to which the light beam reflected by the movable half mirror 201 is guided. This distance measurement/light metering sensor 217 consists of a sensor for distance measurement and a light metering sensor. The light metering sensor includes multi-zone photometric elements for dividing the subject image to measure the brightness of the subject image. The distance measurement sensor is a focus detection sensor for measuring a focusing distance using a TTL phase-difference method. The output of the distance measurement/light metering sensor 217 is sent to a distance measurement/light-metering processing circuit 219. The distance measurement/light-metering processing circuit 219 outputs an evaluation metering value based on the output of the light metering sensor, while it measures a defocus amount of the subject image formed through the lenses 101, 101b based on the output of the distance measurement sensor. The distance measurement sensor and the light metering sensor can be constructed either separately or as one unit.

A focal-plane type shutter 203 for exposure time control and blocking light entering the CCD 221 is arranged behind the movable half mirror 201 on the shooting optical path as the optical axis of the lenses 101a, 101b. The driving of this shutter 203 is controlled by a shutter drive mechanism 213. A dust-proof filter 205 is arranged behind the shutter 203. This is a filter to prevent dust entering from the mount opening portion of the camera body 20 or generated inside the body from clinging to the CCD 221 or other optical elements, casting the shadows of dust specks on images, and hence making the images unsightly. A piezoelectric element 207 is fixed around the entire perimeter or in a portion of the perimeter of the dust-proof filter 205. This piezoelectric element 207 is connected to a dust-proof filter driving circuit 211 and driven by this circuit. The piezoelectric element 207 is driven by the dust-proof filter driving circuit 211 to vibrate the dust-proof filter 205 with a predetermined ultrasonic wave in order to remove dust adhering to the front face of the dust-proof filter 20S using the vibration. Note that the present invention is not limited to the structure using the ultrasonic wave vibration like in the embodiment as long as it can remove dust from the image pickup device such as the CCD itself or the optical element(s) provided in front of the image pickup device. This structure can of course be replaced by any of various methods as appropriate, such as to blow the dust off through a flow of air using an air pump or the like, or to remove dust by collecting it with electrostatic action.

An infrared cut-off filter 209 is arranged behind the dust-proof filter 205 to cut infrared light components from the subject light beam, and an optical low-pass filter 210 for removing high frequency components from the subject light beam is arranged behind the infrared cut-off filter 209. Further, the CCD 221 (first light-receiving sensor) as the image pickup device is arranged behind the optical low-pass filter 210 to photoelectrically convert the subject image formed through the lenses 101a, 101b into an electric signal, and these dust-proof filter 205, infrared cut-off filter 209, optical low-pass filter 210, and CCD 221 are housed in a package hermetically sealed, not shown. The components are arranged to prevent dust from entering the package. In the embodiment, the CCD is used as the image pickup device, but the present invention is not limited to the CCD, and any other two-dimensional image pickup device such as a CMOS (Complementary Metal Oxide Semiconductor) can of course be used.

The CCD 221 is connected to an image pickup device driving circuit 223, and the driving thereof is controlled by a control signal from an I/O circuit 239. The photoelectrically converted analog signal output from the CCD 221 through the image pickup device driving circuit 223 is amplified and subjected to analog-digital conversion (AD conversion). The image pickup device driving circuit 223 is connected to an image processing circuit 227. This image processing circuit 227 performs various image processing such as digital amplification of digital image data (digital gain adjustment processing), color correction, gamma (γ) correction, contrast correction, black-and-white/color mode processing, processing for electronic finder display, etc. The image processing circuit 227 is connected to a data bus 261. Connected to this data bus 261 other than the image processing circuit 227 are, as will be described in detail later, a sequence controller (hereinafter referred to as “body CPU”) 229, a compression/decompression circuit 231, a video signal output circuit 233, an SDRAM control circuit 237, an I/O circuit 239, a communication circuit 241, a recording medium control circuit 243, a flash memory control circuit 247, and a switch detection circuit 253

The body CPU 229 connected to the data bus 261 controls the operation of this digital camera. The compression/decompression circuit 231 connected to the data bus 261 is a circuit for compressing image data stored in the SDRAM 238 using JPEG or TIFF format. Note that the image compression format is not limited to JPEG or TIFF, and any other compression method can be employed. The video signal output circuit 233 connected to the data bus 261 is connected to the rear LCD monitor 26 functioning as a display device for the electronic finder and the intra-finder LCD monitor 29 (abbreviated as “intra-F” LCD monitor in FIG. 2) through an LCD monitor drive circuit 235. The video signal output circuit 233 is a circuit for converting image data, stored in the SDRAM 238 or on the recording medium 245, into a video signal for display on the rear LCD monitor 26 and/or the intra-finder LCD monitor 29. The rear LCD monitor 26 is arranged on the backside of the camera body 20, but the location thereof is not limited to the backside. The rear LCD monitor 26 can be arranged in any position as long as the camera user can view it, and be of any type other than the LCD type. The intra-finder LCD monitor 29 is arranged at a position capable of being viewed by the camera user through the finder eyepiece part 33. Like the rear LCD monitor 26, the intra-finder LCD monitor 29 can also be of any type other than the LCD type. Note that it is possible to provide only the rear LCD monitor 26 for subject image viewing without the finder eyepiece part 33 and the intra-finder LCD monitor 29.

The SDRAM 238 is connected to the data bus 261 through the SDRAM control circuit 237. This SDRAM 238 is a buffer memory for temporary storage of image data processed by the image processing circuit 227 or image data compressed by the compression/decompression circuit 231. The I/O circuit 239 connected with the dust-proof filter driving circuit 211, the shutter drive mechanism 213, the movable mirror driving mechanism 215, the distance measurement/light-metering processing circuit 219, and the image pickup device driving circuit 223 mentioned above controls input and output of data to and from each circuit such as the body CPU 229 through the data bus 261. The communication circuit 241 connected to the lens CPU 111 through the communication contact 300 is connected to the data bus 261 to communicate with the body CPU 229 and the like for exchange of data and communication of control instructions.

The recording medium control circuit 243 connected to the data bus 261 is connected to the recording medium 245 to control the recording of image data and the like onto the recording medium 245. This recording medium 245 is a card type medium to be removably loaded into the camera body 20. Alternatively, the digital camera can be configured such that a small-size hard disk unit or a radio communication unit is connectable to the camera body 20.

The flash memory control circuit 247 connected to the data bus 261 is connected to a flash memory 249. This flash memory 249 stores a program for controlling the overall flow of the camera, and the body CPU 229 controls the digital camera according to the program stored in this flash memory. The flash memory 249 is an electrically rewritable nonvolatile memory.

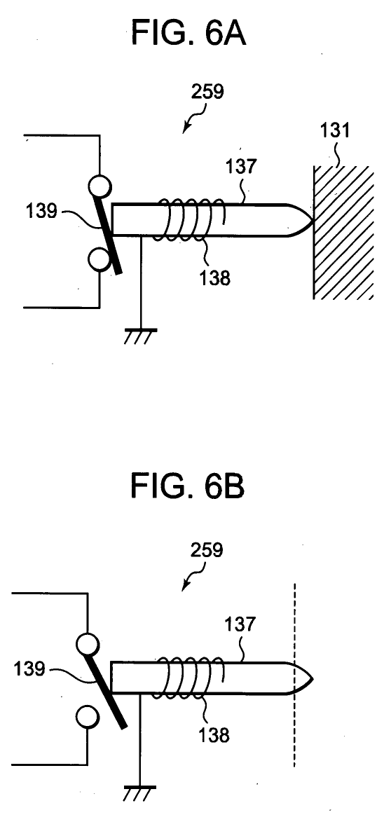

Various switches 255 include, other than a power switch 257 to be turned on/off in conjunction with the movement of the power switch lever 23 for controlling power supply to the camera body 20 or lens barrel 10, switches for detecting first and second strokes of the shutter release button 21, a switch linked with the playback button 27 to instruct a playback mode, switches linked with the arrow pad 30 used to instruct the movement of the cursor on the screen of the rear LCD monitor 26, switches linked with the mode dial 22 to instruct respective shooting modes, an OK switch linked with the OK button 31 to confirm each selected mode or the like, the mounting/demounting detection switch 259, etc. are connected to the data bus 261 through the switch detection circuit 253. The structure of the mounting/demounting detection switch 259 will be described later with reference to FIG. 6.

Referring next to FIG. 3, drive means and retracting means for the movable half mirror 201 will be described. A half mirror 401, which transmits part of a subject light beam and reflects the remaining part of the subject light beam, is held by a mirror frame 403. This mirror frame 403 is rotatable around a shaft 411 inserted into a through-hole 403a. In this case, the rotation axis 201a in FIG. 2 is the central axis of the shaft 411. Both ends of an open spring 407 are engaged between a pin 409 fixed to the camera body 20 and a drive pin 405 embedded in the mirror frame 403, respectively, and a coil portion of this open spring 407 is wound around the shaft 411. The mirror frame 403 is urged counterclockwise (in arrow A direction) in FIG. 3 by the spring force of this open spring 407. The drive pin 405 is engaged with one end of a locking lever 413, and a cam pin 415 embedded in the other end of this locking lever 413 is in engaging contact with a mirror cam 417.

The rotation center of the locking lever 413 is pivotally supported by a mirror box, not shown, and the locking lever 413 is urged counterclockwise (in arrow B direction) in FIG. 3 by the spring force of the open spring 407 through the drive pin 405, bringing the cam pin 415 of the locking lever 413 into press contact with the cam surface of the mirror cam 417. The cam surface of the mirror cam 417 is so formed that the radial length from the rotation center varies. In other words, it is formed such that the distance from the rotation center will be long at a locked position 417a and shorter at a lock-released position 417b than at the locked position 417a on the cam surface. Further, the cam surface is formed counterclockwise from the locked position 417a to the lock-released position 417b with a step level difference 417c therebetween to shift smoothly from the lock-released position 417b to the locked position 417a.

When the locked position 417a of the mirror cam 417 is in contact with the cam pin 415, since the locking lever 413 is restricted by the mirror cam 417 not to rotate in the arrow B direction, the mirror frame 403 is retained in the reflecting position. Then, when the mirror cam 417 is rotated clockwise in FIG. 3 from this position via the step level difference 417c to a position where the lock-released position 417b comes into contact with the cam pin 415, the locking lever 413 becomes rotatable in the arrow B direction. This causes the mirror frame 403 to move in the arrow A direction by the urging force of the open spring 407 to the retracted position. The mirror cam 417 is driven to rotate by a motor, not shown.

Since the movable half mirror 201 is thus constructed, when the cam pin 415 is driven by a motor, not shown, to the position where it comes into contact with the lock-released position 417b, the mirror frame 403 and the locking lever 413 rotate in the arrow B direction by the urging force of the open spring 407 to move the mirror frame 403 to the retracted position indicated by a chain double-dashed line in FIG. 3. Under this condition, when the mirror cam 417 is rotated by the motor to the locked position 417a where it comes into contact with the cam pin 415, the locking lever 413 is rotated clockwise (in the opposite direction of the arrow B) to rotate the mirror frame 403 clockwise (in the opposite direction of the arrow A) through the drive pin 405 against the urging force of the open spring 407, thereby locating the mirror frame 403 at the reflecting position as indicated by a solid line in FIG. 3.

It is further preferable that the above-mentioned retracted position be so arranged that even when the lens barrel 10 is detached, the camera user cannot touch the mirror surface directly.

FIG. 6 contains schematic views showing the mounting/demounting detection switch 259 for detecting the mounting/demounting state of the lens barrel 10 with respect to the camera body 20. An interlocking pin 137 provided in the mounting part of the camera body 20 where the lens barrel 10 is mounted is urged by a pressing spring 138 to project from the camera body 20. One end of this interlocking pin 137 on the camera body side is in contact with a lens mounting/demounting switch 139, and the lens mounting/demounting switch 139 is urged by a spring into an open position. Here, reference numeral 131 denotes a lens-side mount part of the lens barrel 10.

Since the mounting/demounting detection switch 259 is thus constructed, when the lens barrel 10 is mounted on the camera body 20, the interlocking pin 137 is pushed in to the left by the lens-side mount part 131 as shown in FIG. 6(A) to turn on the lens mounting/demounting switch 139, i.e., to turn on the mounting/demounting detection switch 259. On the other hand, when the lens barrel 10 is removed from the camera body to release the interlocking pin 137 from being pushed in by the lens-side mount part 131 as shown in FIG. 6(B), the interlocking pin 137 is urged by the urging force of the pressing spring 138 to project to the right in FIG. 6 to turn off the lens mounting/demounting switch 139, i.e., to turn off the mounting/demounting detection switch 259. Note that the detection of the mounting/demounting state of the lens barrel 10 is not limited to use of the mechanical detection switch as in the embodiment. For example, a photoelectric detection switch using a photosensor can also be employed. In addition, there are various methods such as a method using communication with the lens CPU 111 and a method of detecting the power status of two contacts to be connected with the lens barrel 10.

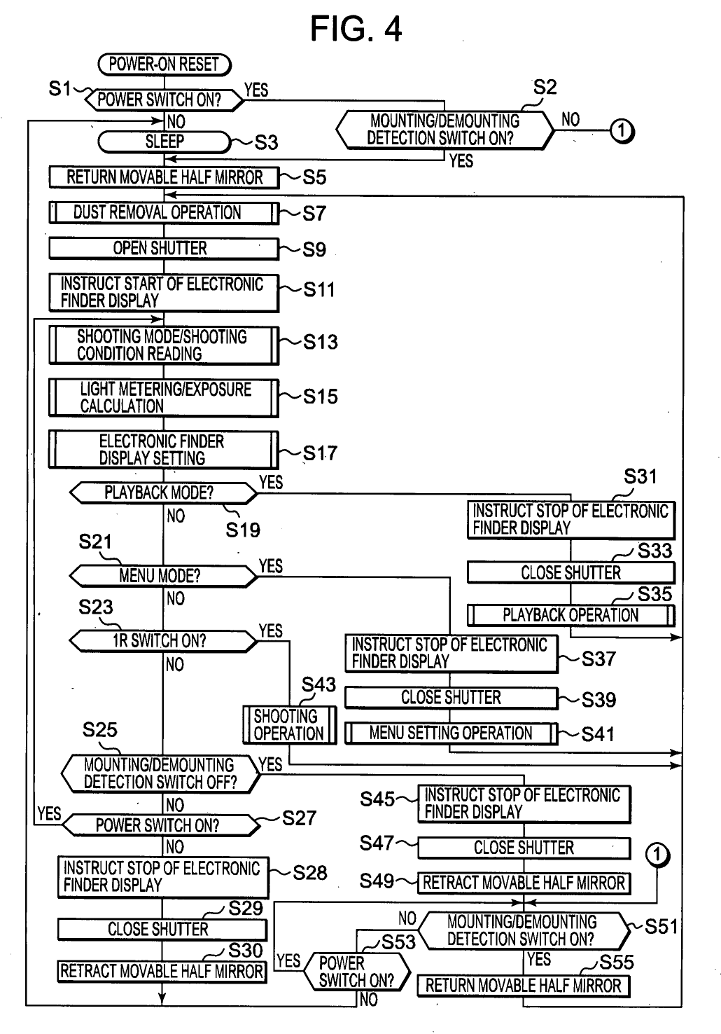

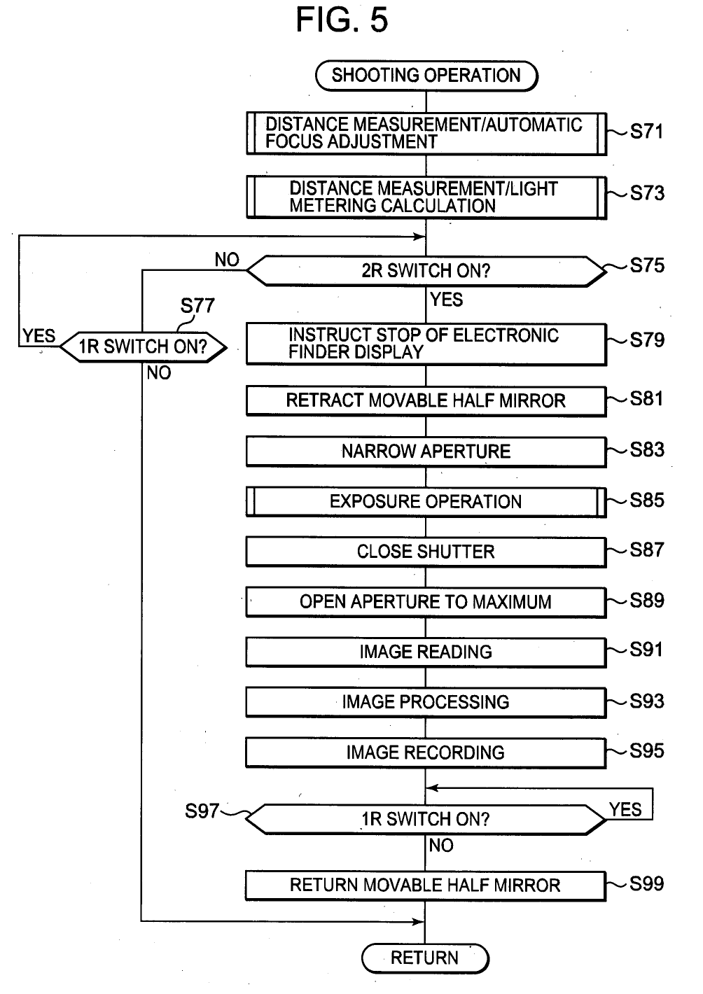

Next, the operation of the digital camera according to the preferred embodiment of the present invention will be described with reference to flowcharts shown in FIGS. 4 and 5. When the digital camera enters a flow of power-on reset as shown in FIG. 4, it is determined whether the power switch 257 of the camera body 20 is on (S1). As a result of determination, if the power switch 257 is off, the procedure goes to step S3 to bring the digital camera into a sleep state (non-operating state) as a power saving state. In this sleep state, the digital camera can return to an operating state only when the power switch 257 shifts from off to on. When the digital camera returns to the operating state, it performs processing corresponding to the power switch on-state in step S5 and below. On the other hand, if the power switch 257 is on in step S1, the digital camera remains active (i.e., the operating state is continued), and the state of mounting/demounting detection switch 259 is determined in step S2 to determine whether the lens barrel 10 is detached or not. This mounting/demounting detection switch 259 is turned off when the lens barrel 10 is detached from the camera body 20, or when it is not mounted properly on the camera body 20. If this switch is off, the procedure shifts to step S51 to be described later. On the other hand, if it is determined in step S2 that the mounting/demounting detection switch 259 is on, the procedure goes to step S5 to perform the processing corresponding to the power switch on-state.

In step S5, the movable half mirror 201 is moved into the shooting optical path. When the power switch 257 is off, the movable half mirror 201 is at the position retracted from the shooting optical path (indicated by the chain double-dashed line in FIG. 2). Therefore, in response to turning on the power switch 257, the movable half mirror 201 is moved into the shooting optical path to guide the subject light beam from the lens barrel 10 to the distance measurement/light metering sensor 217 in order to perform light metering and distance measurement.

Next, a dust removal operation of the dust-proof filter 205 is performed (S7). This operation is to remove dust and the like sticking to the dust-proof filter 205 using the ultrasonic wave as mentioned above by applying a drive voltage to the piezoelectric element 207 from the dust-proof filter driving circuit 211.

Then, an opening operation of the shutter 203 is performed through the shutter drive circuit 213 (S9). Thus, since the subject light beam transmitted through the movable half mirror 201 is not blocked by the shutter 203, a subject image is formed on the CCD 221. Then, the start of electronic finder display is instructed so that a moving image of the subject will be displayed on the rear LCD monitor 26 using image data captured by this CCD 221 (S11). The operation of the electronic finder display is controlled by the image processing circuit 227 in response to this start instruction.

Next, if there is information, such as the shooting mode set by the mode dial 22 and the like, the ISO sensitivity, the shutter speed and/or the aperture value manually set, etc., these shooting conditions are read (S13). Then, the subject brightness is measured by the distance measurement/light metering sensor 217 to calculate the amount of exposure in order to calculate exposure control values such as the shutter speed and the aperture value from the calculated amount of exposure according to the shooting mode/shooting conditions (S15). Further, the electronic finder display setting is made using the light-metering values, the amount of exposure, and the like (S17). In this step, in order to set the conditions of the electronic shutter speed and the sensitivity for driving the CCD 221, calculation and setting operations are performed based on the calculation results of the light-metering values and the amount of exposure determined in step S15, or using the previous displayed image, to display an image having a proper brightness (or color value) on the rear LCD monitor 26 and/or the intra-finder LCD 29.

Next, the procedure goes to step S19 to determine whether the mode is the playback mode or not. This playback mode is a mode in which, when the playback button 27 is pressed, still image data recorded on the recording medium 245 is read and displayed on the rear LCD monitor 26 and/or the intra-finder LCD 29. As a result of determination, if the playback mode is set, the procedure shifts to step S31 to instruct the image processing circuit 227 to stop the electronic finder display. Then, after the shutter 203 is closed (S33), the still image data recorded on the recording medium 245 is read, decompressed by the compression/decompression circuit 231, and playback-displayed on the rear LCD monitor 26 and/or the intra-finder LCD 29 through the video signal output circuit 233 and the LCD monitor drive circuit 235 (S35). During playback, if any other manual operation is performed such as the half-press of the release button 21, the playback operation is terminated and the procedure returns to step S7 to repeat the above-mentioned operation steps.

Returning to step S19, if the playback mode is not set, the procedure goes to step S21 to determine whether the menu mode is set. This is to determine whether the menu button 28 is pressed to set the menu mode. As a result of determination, if the menu mode is set, an instruction to stop the electronic finder display is output in the same manner when the playback mode is set (S37), and an instruction to close the shutter 203 is output (S39). After that, the menu setting operation is performed (S41). In the menu setting operation, various settings can be made, such as white balance setting, ISO sensitivity setting, and drive mode setting. After completion of the menu setting operation, the procedure returns to step S7 to repeat the above-mentioned operation steps.

Returning to step S21, if the menu mode is not set as a result of determination, the procedure goes to step S23 to determine whether the release button 21 has been pressed halfway, i.e., whether 1R switch is on. As a result of determination, if 1R is on, the procedure shifts to step S43 to perform a shooting operation subroutine for performing shooting preparation and shooting operations. The details of this subroutine will be described later with reference to FIG. 5. After completion of the shooting operation subroutine, the procedure returns to step S7 to repeat the above-mentioned operation steps.

Returning to step S23, if 1R switch is off as a result of determination, the procedure goes to step S25 to determine whether the mounting/demounting detection switch 259 is off or not like in step S2. When the lens barrel 10 is detached, an instruction to stop (prohibit) the electronic finder display is output like in steps S31 and S33 in the playback mode (S45), and the shutter 203 is closed (S47). After that, the movable half mirror 201 is retracted (S49). The retraction is accomplished, as mentioned above, by driving the motor to rotate the mirror cam 417 and hence to rotate the mirror frame 403 by the urging force of the open spring 407 to the position retracted from the shooting optical path (position indicated by the chain double-dashed line in FIGS. 2 and 3).

After completion of retracting the movable half mirror 201, or when it is determined in step S2 that the mounting/demounting detection switch 259 is off, the procedure shifts to step S51 to determine whether the mounting/demounting detection switch 259 is on. This is to determine whether the lens barrel 10 is remounted after removal of the lens barrel 10 is detected in step S25. As a result of determination, if it is mounted, the procedure goes to step S55 to return the movable half mirror 201. In other words, as mentioned above, the motor is driven to rotate the mirror cam 417 and hence to rotate the locking lever 413 clockwise along the cam surface against the urging force of the open spring 407, thereby inserting the mirror frame 403 into the optical path of the lenses 101a, 101b. After completion of returning the movable half mirror 201, the procedure returns to step S7 to repeat the above-mentioned operation steps.

Returning to step S51, if the mounting/demounting detection switch 259 is off, the procedure goes to step S53 to determine whether the power switch 257 is on. When the lens barrel 10 is removed and the power switch 257 is on, even if any of the various operation button is operated, the camera operation is disabled to prevent malfunction or failure because the mount opening portion remains open. To this end, the digital camera enters a waiting state in which the mounting state of the lens barrel 10 and the operation state of the power switch lever 23 are determined repeatedly in steps S51 and S53, respectively. In step S53, if it is determined that the power switch 257 is off, the procedure returns to step S3 to bring the digital camera into the sleep state. Note that, if it is determined in step S51 that the lens barrel 10 remains detached, the procedure can omit step S53 and return to step S3 to bring the digital camera into the sleep state. Note further that any other modifications to the procedure are possible, such as to create a loop to go to step S9 to perform an operation based on actuation of any of the various operation buttons.

Returning to step S25, if the mounting/demounting detection switch 259 is on (No in step S25) as a result of determination, i.e., when the lens barrel 10 is mounted on the camera body, the procedure goes to step S27 to determine whether the power switch 257 is on. As a result of determination, if it is on, the procedure returns to step S13 to repeat the above-mentioned steps. Since the subject light beam transmitted through the movable half mirror 201 is not blocked by the shutter 203 after the electronic finder display is started at step S11 unless any of the various operation buttons and the like is operated step in S19 and below, the subject image is formed on the CCD 221, and the electronic finder display is provided to display image data captured by this CCD 221 as a moving image on the rear LCD monitor 26 and/or the intra-finder LCD 29. On the other hand, if it is determined in step S27 that the power switch 257 is off, the image processing circuit 227 is instructed to stop the electronic finder display (S28) and the closing operation of the shutter 203 is performed (S29) like in steps S31 and S33. After that, like in the above-mentioned step S49, the movable half mirror 201 is retracted (S30), and the procedure returns to step S3 to bring the digital camera into the sleep state.

Thus, in the embodiment, the digital camera capable of providing the electronic finder display is configured to insert the movable half mirror 201 into the shooting optical path upon power-on to reflect part of the subject light beam into the distance measurement/light metering sensor 217. This is convenient because light metering and distance measurement can be performed immediately after power-on.

Further, in the power-on reset routine, when removal of the lens barrel 10 is detected by the mounting/demounting detection switch 259 (S25), the movable half mirror 201 is retracted from the shooting optical path, while when remounting of the lens barrel 10 is detected by the mounting/demounting detection switch 259 (S51), the movable half mirror 201 is inserted into the shooting optical path. Therefore, when the lens barrel 10 is detached and the mount part is open, even if the camera user or the like inserts a cleaning tool or the like from the mount opening portion, there is no danger that the movable half mirror 201 will be damaged or get finger marks because the movable half mirror 201 is retracted.

Further, even when the lens barrel 10 is detached upon power-off, since the movable half mirror 201 is retracted, there is also no danger that the camera user or the like damages the movable half mirror 201 or leaves finger marks thereon. Upon power-on of the camera, since the movable half mirror 201 is inserted into the shooting optical path, the electronic finder display operation can be performed concurrently with the distance measurement and light metering operations.

Referring next to FIG. 5, the shooting operation subroutine in step S43 will be described. As mentioned above, this subroutine is performed at the half-press of the release button 21. First, distance measurement/automatic focus adjustment is performed (S71). Since the movable half mirror 201 is inserted into the shooting optical path and part of the subject light beam is reflected into the distance measurement/light metering sensor 217, the distance measurement/light-metering processing circuit 219, the body CPU 229, and the like detect a defocus amount of the lenses 101a, 101b by a TTL phase-difference method using this subject light beam, and based on this detected defocus amount, the optical system driving mechanism 107 drives the lenses 101a, 101b to a focus position through the lens CPU 111.

Next, light metering/exposure amount calculations are made (S73). This is also performed in such a manner that the subject light beam reflected by the movable half mirror 201 is received by the distance measurement/light metering sensor 217 and processed by the distance measurement/light-metering processing circuit 219 to detect subject brightness BV. The body CPU 229 uses this subject brightness BV to determine the amount of exposure EV and further to determine the exposure conditions such as the shutter speed and the aperture value according to the shooting mode and the like.

Next, it is determined whether the release button 21 is fully pressed, i.e., whether 2R is on (S75). As a result of determination, if it is off, the procedure goes to step S77 to determine whether 1R is on or not. If the release button 21 remains pressed halfway after jumping to this shooting operation subroutine at the half-press of the release button 21, the digital camera enters a waiting state in which determinations in steps S75 and S77 are repeated. Then, when the camera user removes his or her finger from the release button 21 to turn 1R off, the procedure returns to step S9 in the power-on reset routine.

Returning to step S75, if 2R switch is on as a result of determination, i.e., when the release button 21 is fully pressed, the procedure goes to an imaging operation for acquiring a still image. First, in step S79, the instruction to stop the electronic finder display is output to the image processing circuit 227. This is to prevent disturbance of the subject light beam incident on the CCD 221 due to the movement of the movable half mirror 201 to the retracted position, opening/closing of the shutter 203, and the like, upon acquiring the still image, and hence the image displayed by the electronic finder on the rear LCD monitor 26 and/or the intra-finder LCD 29 from becoming unsightly or visually undesirable. Then, the movable half mirror 201 is retracted in the same manner as in step S49 (S81).

Then, the aperture drive mechanism 109 narrows the aperture 103 through the lens CPU 111 to a set aperture value or the aperture value calculated in S73 (S83). After completion of narrowing the aperture, an exposure operation is performed by the CCD 221 (S85). Since the movable half mirror 201 is at the retracted position, the entire subject light beam that passed through the lenses 101a, 101b is focused to form the subject image on the CCD 221. Under this condition, resetting of the electronic shutter of the CCD 221 is released to start accumulation of electric charges of photoelectric conversion current representing the subject image. Then, when the exposure time manually preset or set in step S73 has elapsed, the electronic shutter of the CCD 221 stops accumulation of the electric charges of the photoelectric conversion signal. In the exposure operation of step S85, the exposure time is controlled by the electronic shutter of the CCD 221, but the present invention is not limited thereto, and the exposure time can also be controlled by the shutter 203. In this case, front and rear curtains of the shutter 203 needs moving to their initial positions before the start of the exposure operation.

Then, the shutter 203 is closed (S87), and an instruction to open the aperture 103 to the maximum is output to the lens CPU 111 (S89). Further, the image signal acquired by the CCD 221 accumulating the electric charges is read out (S91), and subjected to image processing through the image processing circuit 227 and the like (S93). Then, after signal compression or the like is performed through the compression/decompression circuit 231, resulting image data is recorded on the recording medium 245 (S95). After completion of recording the image data, it is determined in step S97 whether 1R switch is on, i.e., whether the release button 21 remains pressed halfway (S97). When 1R switch is turned off, the procedure goes to step S99 to return the movable half mirror 201 in the same manner as in step S55. After completion of returning the movable half mirror 201, the procedure returns to the power-on reset routine.

In the shooting operation subroutine of the embodiment, the movable half mirror 201 is retracted during the imaging operation for acquiring the still image. This can avoid reducing the amount of light transmitted through the movable half mirror 201, and hence increase the amount of subject light upon acquiring the still image, enabling shooting at a faster shutter speed. Further, after completion of the imaging operation, the movable half mirror 201 is returned in step S99. Therefore, when the release button 21 is pressed halfway again after shooting, light metering and distance measurement can be performed immediately and concurrently with the electronic finder display.

In the embodiment, the operating and non-operating states of the camera are switched by the power switch 257. However, in addition to the switching operation of this power switch 257, determination means may be provided as an alternative example to determine whether the camera has been operated or not for a predetermined period of time. In this case, when the camera has not been operated for the predetermined period of time, the determination means determines that the camera is in the non-operating state to start retracting the movable half mirror 201. Specifically, a timer to be reset in response to actuation of any of the various operating members and operation buttons, such as the release button 21, the mode dial 22, the control dial 24, the playback button 27, the menu button 28, the arrow pad 30, and the OK button, is provided so that the movable half mirror will be retracted in step S29 at the time when the predetermined period of time counted by this timer has elapsed.

As described above, according to the embodiment, the digital camera capable of providing the electronic finder display is configured to insert the movable half mirror 201 into the shooting optical path upon activation of the camera to reflect part of the subject light beam into the distance measurement/light metering sensor 217. This is convenient because light metering and distance measurement can be performed concurrently with the electronic finder display immediately after the release button 21 is pressed halfway to turn 1R on during the electronic finder display.

Further, in the embodiment, the power-on and the power-off can be set by the power switch 257, and the movable half mirror 201 is made movable between the position inserted in the shooting optical path and the position retracted from the shooting optical path in such a manner to move the movable half mirror 201 to the retracted position upon power-on. Therefore, even if a cleaning tool or the like is inserted from the mount opening portion of the camera body during power-off, there is no danger of damaging the movable half mirror 201. On the other hand, the movable half mirror 201 is moved from the position retracted from the shooting optical path to the position inserted into the shooting optical path-upon power on, so that light metering and distance measurement can be performed immediately. The non-operating state of the camera includes, but not limited to, turning off the power switch. As mentioned above, the non-operating state is also determined when the camera has not been operated for a predetermined period of time.

Further, in the embodiment, the movable half mirror 201 is moved to the position retracted from the shooting optical path when the lens barrel 10 is removed. Therefore, even if a cleaning tool or the like is inserted from the mount opening portion of the camera body, there is no danger of damaging the movable half mirror 201. Then, when the lens barrel 10 is remounted on the camera body, the movable half mirror 201 is inserted into the shooting optical path. This enables distance measurement and light metering to be performed concurrently with the electronic finder display. In the embodiment, the CCD 221 as the image pickup device receives light transmitted through the movable half mirror 201 and the distance measurement/light metering sensor 217 receives light reflected by the movable half mirror 201. Conversely, the digital camera can be configured such that the CCD 221 receives reflected light and the distance measurement/light metering sensor 217 receives transmitted light. Further, in the embodiment, the sleep state as the power saving state is described as an example of the non-operatinq state, but the non-operating state also includes the power-off state in which the camera consumes no power at all.

In the embodiment, although the lens barrel 10 is described as an example of the part to be mounted on the opening portion of the camera body 20 of the present invention, it is not limited to the lens barrel 10. For example, various other devices or accessories such as a bellows and an extension tube can be considered to be mounted. Further, the present invention is of course applicable to cameras designed specifically to be attached to various other equipment, such as microscopes, binoculars, etc. Thus, the present invention is also applicable to those other than general-purpose digital cameras as long as they have an opening portion through which the half mirror is likely to be exposed to the outside.

While there has been shown and described what is considered to be a preferred embodiment of the invention, it will, of course, be understood that various modifications and changes in form or detail could readily be made without departing from the spirit of the invention. It is therefore intended that the invention not be limited to the exact form described and illustrated, but constructed to cover all modifications that may fall within the scope of the appended claims.

What is claimed is:

1. A lens-interchangeable digital camera capable of removably mounting a photographing lens, the digital camera comprising:
a mirror member capable of being moved in and out of an optical path of the photographing lens and having properties to reflect part of a subject light beam and transmit the remaining part of the subject light beam in the optical path;
a drive mechanism for moving the mirror member into or out of the optical path of the photographing lens;
a focus detection sensor for receiving a light beam reflected by the mirror member to detect a focus state of the photographing lens when the mirror member is located in the optical path;
an image pickup device for receiving the subject light beam transmitted through the mirror member to output a subject image signal when the mirror member is located in the optical path;
an electronic finder for displaying the subject image signal output from the image pickup device; and
a control circuit for stopping the display operation of the electronic finder and retracting the mirror member from the optical path of the photographing lens when the photographing lens is removed while the display operation of the electronic finder is being performed.

2. The digital camera according to claim 1 wherein when the digital camera is brought into a non-operating state while the display operation of the electronic finder is being performed, the control circuit stops the display operation of the electronic finder and retracts the mirror member from the optical path of the photographing lens.

3. The digital camera according to claim 2 wherein if the photographing lens is mounted upon shifting the digital camera from the non-operating state to an operating state, the control circuit moves the mirror member into the optical path of the photographing lens to start the display operation of the electronic finder.

4. The digital camera according to claim 1 wherein when the photographing lens is remounted, the control circuit moves the mirror member back into the optical path of the photographing lens to restart the display operation of the electronic finder.

5. The digital camera according to claim 1 wherein the mirror member is a thin-film mirror or a glass mirror with a thickness of 0.2 mm or less.

6. The digital camera according to claim 1 wherein when an operation for changing an operation mode of the digital camera is performed while the display operation of the electronic finder is being performed, the control circuit stops the display operation of the electronic finder.

7. The digital camera according to claim 1 wherein the retracted position of the mirror member is a position where a light-receiving window of the focus detection sensor is covered by the mirror member.

8. A lens-interchangeable digital camera capable of removably mounting a photographing lens, the digital camera comprising:
a mirror member capable of being moved in and out of an optical path of the photographing lens and having properties to reflect part of a subject light beam and transmit the remaining part of the subject light beam in the optical path;
a drive mechanism for moving the mirror member into or out of the optical path of the photographing lens;
a light-receiving sensor for receiving a light beam transmitted through or reflected by the mirror member to output a subject image signal when the mirror member is located in the optical path; and
a control circuit for stopping the signal output operation of the light-receiving sensor and moving the mirror member out of the optical path of the photographing lens when the photographing lens is removed.

9. The digital camera according to claim 8 wherein the mirror member is a thin-film mirror or a glass mirror with a thickness of 0.2 mm or less.

10. The digital camera according to claim 8 wherein when the digital camera is brought into a non-operating state, the control circuit stops the signal output operation of the light-receiving sensor and retracts the mirror member from the optical path of the photographing lens.

11. The digital camera according to claim 10 wherein if the photographing lens is mounted upon shifting the digital camera from the non-operating state to an operating state, the mirror member is moved into the optical path of the photographing lens to allow the signal output operation of the light-receiving sensor.

12. The digital camera according to claim 10 wherein when the photographing lens is remounted, the mirror member is moved back into the optical path of the photographing lens to allow the signal output operation of the light-receiving sensor.

13. The digital camera according to claim 8 wherein the light-receiving sensor is an image pickup device or a focus detection sensor.

14. A lens-interchangeable digital camera capable of removably mounting a photographing lens, the digital camera comprising:
a mirror member capable of being moved in and out of an optical path of the photographing lens and having properties to reflect part of a subject light beam and transmit the remaining part of the subject light beam in the optical path;
a drive mechanism for moving the mirror member into or out of the optical path of the photographing lens;
a light-receiving sensor for receiving a light beam transmitted through or reflected by the mirror member to output a subject image signal when the mirror member is located in the optical path; and
a control circuit for moving the mirror member out of the optical path of the photographing lens and stopping the operation of the light-receiving sensor in such a state that the photographing lens has been removed.

15. The digital camera according to claim 14 wherein the mirror member is a thin-film mirror or a glass mirror with a thickness of 0.2 mm or less.

16. A lens-interchangeable digital camera capable of removably mounting a photographing lens, the digital camera comprising:
a mirror member capable of being moved in and out of an optical path of the photographing lens, the mirror member being a thin-film mirror or a glass mirror with a thickness of 0.2 mm or less and having a property to reflect part of incident light; and
a control part for moving the mirror member to a predetermined retracted position when the photographing lens is removed,
wherein the retracted position is a position where the mirror member is less likely to interfere with an extraneous material entering from an opening of a lens mount part.

17. A control method for a lens-interchangeable camera for capturing a subject image through a mirror member to enable displaying of a moving picture based on the captured subject image, the mirror member capable of being moved in and out of an optical path of a photographing lens and having a light-transmissive property, the control method comprising the steps of:
stopping the moving picture display and moving the mirror member out of the optical path of the photographing lens when removal of the photographing lens is detected while the moving picture is being displayed; and
moving the mirror member back into the optical path and restarting the moving picture display when remounting of the photographing lens is detected.
